(19) United States
(12) Patent Application Publication
(10) Pub. No.: US 2009/0016571 A1
(43) Pub. Date: Jan. 15, 2009

(54) Blur display for automotive night vision systems with enhanced form perception from low-resolution camera images

(76) Inventors: Louis Tijerina, Dearborn, MI (US); Samuel Edward Ebenstein, Southfield, MI (US); Kwaku O. Prakah-Asante, Commerce Township, MI (US); Yelena Mordechai Rodin, Southfield, MI (US)

Correspondence Address: RADER, FISHMAN & GRAUER PLLC;FORD GLOBAL TECHNOLOGIES, INC., 39533 WOODARD AVENUE, SUITE #140, BLOOMFIELD HILLS, MI, 48304, US

(21) Appl. No.: 11/731,354

(22) Filed: Mar. 30, 2007

(51) Int. Cl. G06K 9/00; G06K 9/40

(52) U.S. Cl. 382/104; 382/264

(57) ABSTRACT

The present invention relates to a night vision system human machine interface and particularly to an HMI display that provides enhanced road scene imagery from low resolution cameras.

### TECHNICAL FIELD OF THE INVENTION

The present invention generally relates to a night-vision system human-machine interface (HMI), and particularly to an HMI visual display that provides enhanced road scene imagery from low-resolution cameras.

The present invention further relates to a method to enhance form perception from low resolution camera images in automotive night display systems by applying a lens to the bezel of a visual display to provide sufficient refraction to blur an image's pixilated elements until a desired form perception is achieved.

The present invention further relates to a method to apply an analog or digital low pass filter with sufficient frequency and order cutoff for the coarseness of the camera image to be perceived in a desired form.

The present invention further relates to a method to apply a median filter to the output of a low resolution night vision camera to enhance the camera image to be perceived in a desired form.

Night vision systems are intended to improve night-time detection of pedestrians, cyclists, and animals. Such systems have been on the market in the United States since Cadillac introduced a Far IR night vision system as an option in the late 1990s. High-resolution night vision cameras can provide the driver with a more picture-like display of the road scene ahead than a low-resolution camera but at greater expense. In particular high resolution Far IR sensors can be very costly. These sensors are often 320×240 pixels. Software techniques have been developed which can detect pedestrians, cyclists and animals using Far IR images of a much lower resolution such as 40×30 pixels. The substantially lower cost of these sensors offers greater potential to be widely deployed on cars and trucks at an affordable price. Unfortunately, the raw images from these sensors are very difficult for the driver to understand and interpret.

The human visual system's response can be analyzed in terms of spatial frequencies. Object details are perceived in the sharp edges of transition between light and dark. Fine details can be mathematically represented as high spatial frequencies. Perception of overall object form, on the other hand, can be represented by low spatial frequencies. It has been known for some time that if higher spatial frequencies are filtered out of a coarse image, the form of the object can generally be identified by the remaining low-frequency content. A blurred image is an example of this effect. The effect can be achieved by squinting, defocusing, and moving away from the coarse picture or moving either the picture or one's head. Alternatively this can be achieved by modifying the image through software manipulation.

In human face recognition, filtering of frequencies about a critical band needed for face recognition is used to accomplish the enhancement. However, automotive applications do not require that level of display information and simpler means of spatial frequency filtering may be sufficient. By analogy, critical band filtering is needed to identify whose face is being displayed. Low pass filtering is sufficient to know if it is a face and not something else.

This fact of human perception has been implemented in many ways, including machine vision, automatic face recognition, and others. However, the application of this invention to a low resolution night vision system represents a unique application. The invention replicates the effect of blurring a coarse image to achieve the form perception desired. Moving away from the coarse image improves form perception but at the same time makes those images smaller, thus introducing other problems for driver perception. The invention maintains the original image size through various methods of software manipulation (e.g., applying a median filter, a low-pass filter, or a band-pas filter specific to the camera and scene characteristics) to provide enhanced form perception from low resolution camera images while at the same time maintaining a constant image display size.

### SUMMARY OF THE INVENTION

The present invention is directed to a night vision HMI video display that allows a driver in a vehicle so equipped to see object forms even though the night vision sensor is of low or coarse resolution. Low camera resolution creates a highly pixilated, abstract image when viewed on a VGA video display. Without further treatment, this image is generally without recognizable form or detail. The lowest resolution images (40×30) appear abstract, without recognizable detail or form. As the resolution increases, perception of both form and details improves. However, such increased resolution has an associated increase in cost of the camera needed to capture increasing levels of detail.

The invention takes the low resolution image and manipulates it so as to improve form perception. The concept is to blur out high spatial frequencies provided by the edges of the low resolution image's block image elements. Form and motion perception are thereby improved by the spatial frequency filtering.

There are several methods contemplated to implement the invention. One method is to apply a lens to the bezel of a video display that provides sufficient refraction to blur the image's pixilated elements. The lens would provide an equivalent visual acuity (e.g., 20/20, 20/40, 20/80, etc.) that matched what is obtained by moving away from the coarse image until the desired form perception was achieved.

Another method is to apply a low-pass digital or analog filter to the camera output so as to achieve the desired effect. The filter's cutoff frequency and order needed for the night vision application would depend on the coarseness of the specific system's camera. This would be empirically determined by human experimentation with representative night vision scenes, dynamically presented at the system's frame rate.

A third method is to apply a median filter to the camera's output. The degree or range of the median filter would be determined empirically to achieve the desired effect. Implementation feasibility, packaging considerations, cost, and human factors requirements will determine the most suitable method for a specific application.

### BRIEF DESCRIPTION OF THE DRAWINGS

FIG. 1 is a schematic representation of a low resolution FAR IR night vision system for use on a vehicle.

FIG. 2 shows a high resolution image captured with a 320×240 FAR IR sensor.

FIG. 3 shows the same image as FIG. 2, captured with a 40×30 FAR IR sensor.

FIG. 4 shows the same image as FIG. 3 which has been subjected to image enhancement to blur edges of the image pixel blocks.

FIG. 5 is a software flow chart showing the method of the image enhancement of the present invention.

### DETAILED DESCRIPTION OF (A) PREFERRED EMBODIMENT(S)

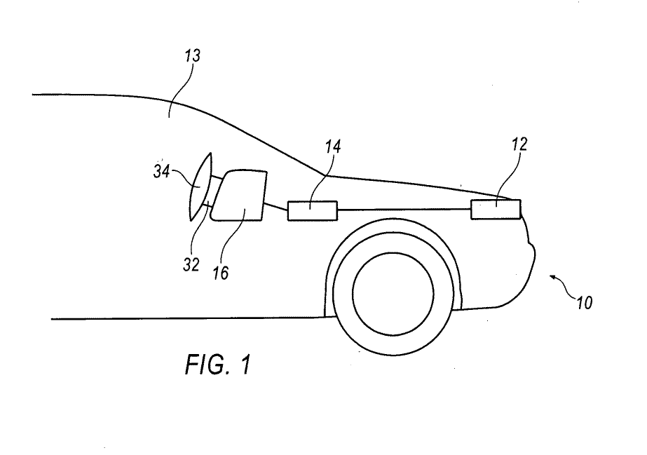

Turning now to the drawings, FIG. 1 is a schematic representation of a low resolution FAR IR night vision system for use on a vehicle. Although it is described as being adapted for use in a vehicle, it is understood by those skilled in the art that the low resolution night vision FAR IR system can be used in any setting, whether vehicle or not.

Specifically, system 10 is comprised of a low resolution camera sensor 12, having a resolution of from about 40×30 pixels, and more preferably having a resolution of about 80×60 pixels. While the stated resolution of the sensor 12 is not limiting, it is understood that high resolution camera sensors of prior systems are relatively expensive when compared to low resolution sensors, and may not be necessary for all applications wherein a night vision system is desired. The sensor is electronically connected to a signal processor 14, which is also electronically connected to a visual display 16. The signal processor functions to receive the signal from the sensor and transmit it to the visual display for viewing by the driver or other occupant of the vehicle. The system 10 is usually mounted in the front of a vehicle 13 with the sensor in forward position relative to a driver and the visual display in close proximity to the driver, or in any other convenient position relative to the driver, so that the driver may process the images detected by the sensor and determine the best course of action in response to the images perceived. However, it is also contemplated that the sensor may be mounted in the rear or in any part of the vehicle from where it is desired to receive images. In addition, although only one system is described, a vehicle may be equipped with more than one such system to provide for multiple images to be transmitted to the driver for processing.

It has been an issue in the industry to provide for a cost effective FAR IR night vision system that will provide the driver with usable images. Some manufacturers have opted to provide for high resolution IR FAR night vision systems that may not be suitable or the most cost effective systems for wide distribution over many product lines. Indeed, the image produced and the cost of the system have, in the past, been seen as tradeoffs of one another. For example, a low resolution sensor was seen as producing pixilated coarse image blocks that may not be useable to the driver, whereas a high resolution sensor that produces a detailed image may be seen as too costly in some applications.

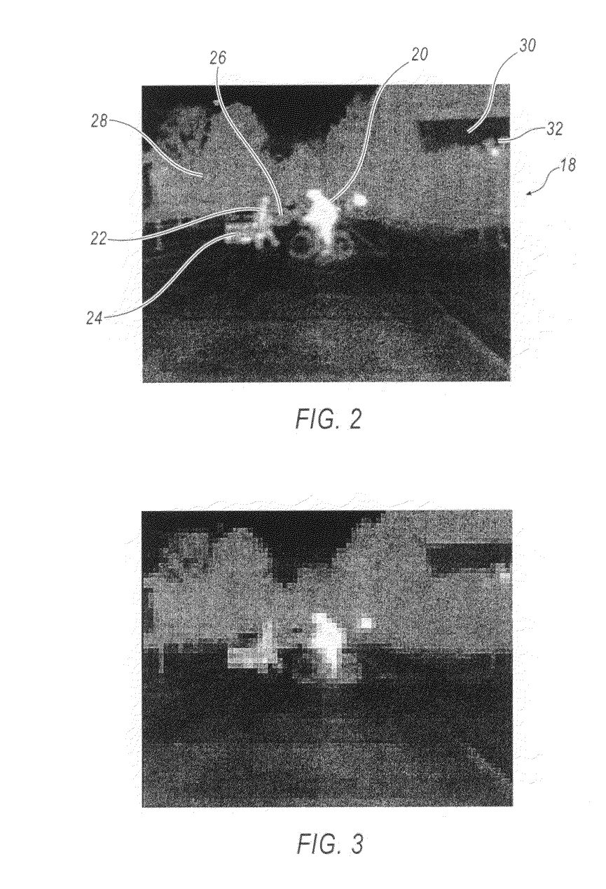

FIG. 2 is a representation of a high resolution image captured with a 320×240 FAR infrared vision sensor. As can be understood by reviewing the night vision image 18 of FIG. 1, an image 20 of a rider on a bicycle, a pedestrian 22, vehicles 24, 26 in opposing lanes of traffic together with trees 28, building 30 and street lamps 32 are apparent. These images are produced with a high resolution IR camera without filtering. It is apparent that the images are defined and highly pixilated, thereby contributing to the fine detail of the images and the ready ability of a driver to perceive the images presented therein as meaningful objects.

By comparison, FIG. 3 is a representation of a low resolution image captured with a low resolution, specifically 40×30, FAR infrared vision camera sensor. In actual practice an 80×60 camera sensor would probably be used, but a smaller image has been used to more easily demonstrate the various methods of making a very course image usable. The image depicted in FIG. 3 is the same image as depicted in FIG. 2, but is produced using a low resolution camera sensor. The contrast between the two images is striking. In the image, the central figure is coarse and the image is comprised of large pixel blocks with contrasted edges. Indeed the central figure appears abstract and almost unintelligible. Such an image can negatively affect form perception and object-and-event detection. One solution to this problem is to provide driver warnings without a video display, e.g., through a warning light, warning tone, haptic seat alert, etc. This solution is potentially problematic. Without a visual display of the road scene, the driver has limited information upon which to assess the situation. Because the night vision system, by definition, is intended to support the driver when headlamps do not illuminate the object, the driver is delayed in picking up potentially critical information through direct vision. The driver does not know what target has been detected, exactly where it is, how fast it is moving (if it is moving at all), what direction it is traveling, and so forth.

Without further processing, the image of FIG. 3 is of limited, if any, value in a practical night vision system. In one aspect, the present invention uses frequency filtering software to blur the sharp contrasts at the edges between the pixel blocks of the image to produce a more useable image. It is known that frequency filtering is based on the Fourier Transform. The operator usually takes an image and a filter function in the Fourier domain. This image is then multiplied with the filter function in a pixel-by-pixel fashion:

G(k,l)=F(k,l)H(k,l)

wherein:
F(k,l) is the input image in the Fourier domain,
H(k,l) the filter foundation, and
G(k,l) is the filtered image.
   To obtain the resulting image in the spatial domain, G(k,l) has to be re-transformed using the inverse Fourier Transform. A low-pass filter attenuates high frequencies and retains low frequencies unchanged. The result in the spatial domain is equivalent to that of a smoothing filter; as the blocked high frequencies correspond to sharp intensity changes, i.e. to the fine-scale details and noise in the spatial domain image. The most simple lowpass filter is the ideal lowpass. It suppresses all frequencies higher than the cut-off frequency D₀ and leaves smaller frequencies unchanged. This may be expressed as:

$$H ( k , l ) = \{ \begin{matrix}1 & if \sqrt{{k}^{2} + {l}^{2}} < {D}_{0} \\ 0 & if \sqrt{{k}^{2} + {l}^{2}} > {D}_{0}\end{matrix}$$

In most implementations, D₀ is given as a fraction of the highest frequency represented in the Fourier domain image.

Better results can be achieved with a Gaussian shaped filter function. The advantage is that the Gaussian has the same shape in the spatial and Fourier domains and therefore does not incur the ringing effect in the spatial domain of the filtered image. A commonly used discrete approximation to the Gaussian is the Butterworth filter. Applying this filter in the frequency domain shows a similar result to the Gaussian smoothing in the spatial domain. One difference is that the computational cost of the spatial filter increases with the standard deviation (i.e. with the size of the filter kernel), whereas the costs for a frequency filter are independent of the filter function. Hence, the spatial Gaussian filter is more appropriate for narrow lowpass filters, while the Butterworth filter is a better implementation for wide lowpass filters.

Bandpass filters are a combination of both lowpass and highpass filters. They attenuate all frequencies smaller than a frequency D₀ and higher than a frequency D₁, while the frequencies between the two cut-offs remain in the resulting output image. One obtains the filter function of a bandpass by multiplying the filter functions of a lowpass and of a highpass in the frequency domain, where the cut-off frequency of the lowpass is higher than that of the highpass.

Instead of using one of the standard filter functions, one can also create a special filter mask, thus enhancing or suppressing only certain frequencies. In this way it is possible, for example, to remove periodic patterns with a certain direction in the resulting spatial domain image.

The Gaussian smoothing operator is a 2-D convolution operator that is used to ‘blur’ images and remove detail and noise. In this sense it is similar to the mean filter, but it uses a different kernel that represents the shape of a Gaussian (‘bell-shaped’) hump. This kernel has some special properties which are detailed below.

The Gaussian distribution in 1-D has the form:

$$G ( x ) = \frac{1}{\sqrt{2 π} σ} {e}^{- \frac{{x}^{2}}{2 {σ}^{2}}}$$

where σ is the standard deviation of the distribution. We have also assumed that the distribution has a mean of zero (i.e. it is centered on the line x=0).

The idea of Gaussian smoothing is to use 2-D distribution as a ‘point-spread’ function, and this is achieved by convolution. Since the image is stored as a collection of discrete pixels it is desirable to produce a discrete approximation to the Gaussian function before performing the convolution. In theory, the Gaussian distribution is non-zero everywhere, which would require an infinitely large convolution kernel, but in practice it is effectively zero more than about three standard deviations from the mean. This permits truncating the kernel at this point.

Once a suitable kernel has been calculated, then the Gaussian smoothing can be performed using standard convolution methods. The convolution can be performed fairly quickly since the equation for the 2-D isotropic Gaussian shown above is separable into x and y components. Thus the 2-D convolution can be performed by first convolving with a 1-D Gaussian in the x direction, and then convolving with another 1-D Gaussian in the y direction. The Gaussian smoothing is the only completely circularly symmetric operator which can be decomposed in such a way. A further way to compute a Gaussian smoothing with a large standard deviation is to convolve an image several times with a smaller Gaussian. While this is computationally complex, it can have applicability if the processing is carried out using a hardware pipeline.

The effect of Gaussian smoothing is to blur an image, in a similar fashion to the mean filter. The degree of smoothing is determined by the standard deviation of the Gaussian. It is understood that larger standard deviation Gaussians require larger convolution kernels in order to be accurately represented.

The Gaussian outputs a ‘weighted average’ of each pixel's neighborhood, with the average weighted ore towards the value of the central pixels. This is in contrast to the mean filter's uniformly weighted average. Because of this, a Gaussian provides gentler smoothing and preserves edges better than a similarly sized mean filter.

One of the principle justifications for using the Gaussian as a smoothing filter is due to its frequency response. Most convolution-based smoothing filters act as lowpass frequency filters. This means that their effect is to remove high spatial frequency components from an image. The frequency response of a convolution filter, i.e., its effect on different spatial frequencies, can be seen by taking the Fourier transform of the filter.

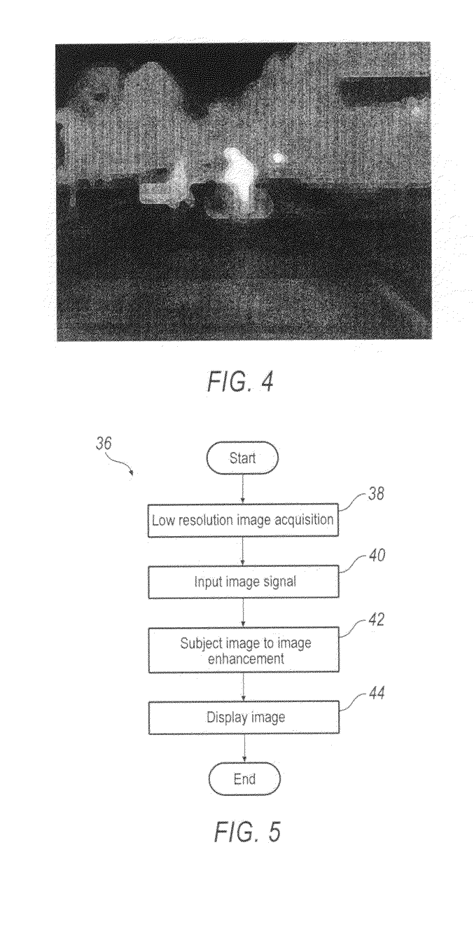

FIG. 4 is a representation of the results of a median filter applied to the image of FIG. 3. A median filter is normally used to reduce noise in an image, and acts much like a mean filter, and in many applications, a mean filter could be applicable. However, those skilled in the art recognize that a median filter preserves the useful detail in an image better that a mean filter.

A median filter, like a mean filter, views each pixel in an image in turn and looks at its nearby pixel neighbors to determine whether it is representative of its surroundings. Instead of simply replacing the pixel value with the mean of the neighboring pixel values, a median filter replaces it with the median of those values. The median is calculated by first sorting all the pixel values from the surrounding neighborhood into numerical order and them replacing the pixel being considered with the middle pixel value.

A mean filter replaces teach pixel in an image with the mean or average value of its neighbors, including itself. This has the effect of eliminating pixel values that are unrepresentative of their surroundings. Mean filtering is usually thought of as convolution filtering. As with other convolutions, it is built around a kernel that represents the shape and size of the neighborhood to be sampled when calculating the mean. Mean filtering is most commonly used to reduce noise from an image.

As previously stated, FIG. 4 is the same image as represented FIG. 3, with the difference that the coarse, highly pixilated image of FIG. 3 has been subjected to median filtering. The median filtering produces an image that blurs the contrasts between the adjacent pixels to achieve a desired form perception. The image is maintained in the original size, but the contrast between the edges of the pixels is blurred such that while it is difficult to discern the face details of the bicycle rider, it is readily apparent that there is a rider in the road and the driver can take appropriate action to conform the operation of the vehicle accordingly.

Turning again to FIG. 1 it may be seen that the visual display unit may be equipped with a bezel 32 or any other structure compatible with the mounting of a lens 34 that provides sufficient refraction to blur the pixilated elements of the image to produce an equivalent desired visual acuity. Thus, by use of a lens system, there is no need to pass the low resolution image through an electronic low pass filtering. Rather, in the manner described with reference to this paragraph, the lens would produce an image from the visual display of an acuity of 20/20, 20/40, or 20/80, or any desired visual acuity, that would match what is obtained by moving away from the coarse image until the desired form perception was achieved.

FIG. 5 is a flow chart of the steps in the method 36 of the present invention. Specifically, step 38 is acquiring a low resolution image. Step 40 is inputting the image signal through the signal processor. Step 42 is subjecting the image to enhancement so that the contrasts between coarse, highly contrasted pixels of the image can be attenuated or smoothed so that a usable image can be perceived. This step can, as previously described, be achieved by passing the image through a digital or analog low pass filter, or it can be achieved by passing the image through a lens attached to the visual display to produce an image with the desired visual acuity. After the contrasts between the coarse highly contrasted pixels have been attenuated, the image is produced in step 44 by displaying the image on a visual display.

The words used to describe the invention are words of description, and not words of limitation. Those skilled in the art will recognize that various modifications and embodiments are possible without departing from the scope and spirit of the invention as set forth in the appended claims.

What is claimed as new and desired to be protected by Letters Patent of the United States is:

1. A night vision imaging system for a vehicle, comprising:
a) a low resolution infrared sensor camera for perceiving an object and producing a pixilated low resolution image block with edges in response;
b) a signal processor adapted for receiving said image signal and processing the image signal into a display signal; and
c) spatial filter adapted to blur out high spatial frequencies provided by said block edges of said low resolution image block to produce a visual image; and
d) a human interface visual display to view the visual image.

2. The imaging system of claim 1, wherein said low resolution infrared sensor camera has a resolution in the range of about 40×30 pixels to 80×60 pixels.

3. The imaging system of claim 1, wherein said filter is a lens applied to a display upon which said image appears; said lens providing sufficient refraction to blur the images pixilated elements to produce a visual acuity sufficient to discern the form of the displayed image.

4. The imaging system of claim 1, wherein said filter is a low pass spatial filter to said camera input; said filter adapted to spatially filter said image block edges dynamically to produce a discernable image.

5. The image system of claim 4, wherein said filter is a low pass digital spatial filter.

6. The image system of claim 4 wherein said filter is a low pass analog spatial filter.

7. The image system of claim 1, wherein same filter is a median spatial filter; said median filter having a range determined empirically based upon said low resolution block image.

8. The image system of claim 1, wherein said display is a night vision human machine interface (HMI) video display.

9. The image system of claim 3, wherein said lens produces a visual acuity of the in the range in the range of about 20/20 to about 20/80.

10. A method of producing usual images form a low resolution night vision system, comprising:
a) acquiring a low resolution image as a signal;
b) inputting said low resolution image signal;
c) subjecting said image to spatial filtering; and
d) displaying said image on human machine interface visual display.

11. The method of claim 10, wherein said spatial filtering is a frequency filter based upon Fourier transform.

12. The method of claim 11, wherein said Fourier transform is the Gaussian method.

13. The method of claim 12, wherein said filter is a Butterworth filter.

14. The method of claim 10, wherein said Fourier transform is a median filter.

15. The method of claim 10, wherein said image is displayed on a human machine interface visual display.

16. A vehicle with a low resolution night vision system, comprising:
a) a low resolution sensor camera to produce an image signal in response to a perceived object;
b) a signal process adapted to receive the image and process the image into a visual signal;
c) a spatial filter to filter the visual signal to produce a visual image; and
d) a human machine interface visual display to display the visual image.

17. The method of claim 16, wherein said spatial filter is a digital filter.

18. The method of claim 16, wherein said spatial filter is an analog filter.

19. The method of claim 16, wherein said filter is at least one lens in close proximity to said visual display to produce an image of desired visual acuity.

20. The method of claim 16, wherein said spatial filter is a median filter.
